(19) United States
(12) Patent Application Publication
(10) Pub. No.: US 2023/0370498 A1
(43) Pub. Date: Nov. 16, 2023

(54) INFERENCE DEVICE, INFERENCE METHOD, AND INFERENCE PROGRAM

(71) Applicant: NIPPON TELEGRAPH AND TELEPHONE CORPORATION, Tokyo (JP)

(72) Inventors: Hiroyuki UEKAWA, Musashino-shi, Tokyo (JP); Eitaro SHIOJI, Musashino-shi, Tokyo (JP); Toshiki SHIBAHARA, Musashino-shi, Tokyo (JP); Mitsuaki AKIYAMA, Musashino-shi, Tokyo (JP)

(73) Assignee: NIPPON TELEGRAPH AND TELEPHONE CORPORATION, Tokyo (JP)

(21) Appl. No.: 18/025,913

(22) PCT Filed: Oct. 16, 2020
(86) PCT No.: PCT/JP2020/039192

§ 371 Date: Mar. 13, 2023

(51) Int. Cl. H04L 9/40

(52) U.S. Cl. CPC H04L 63/20

(57) ABSTRACT

An inference device 10 converts configuration information of a network and information such as a security log into a predicate of the solution set programming. The inference device 10 obtains, as a solution set, a combination of predicates derived by a derivation rule from predicates obtained by conversion, and predicates not constrained by the constraint rule among predicates obtained by conversion using a method of solution set programming. The predicate of the solution set indicates, for example, whether a node included in the network is a client or a proxy.

### TECHNICAL FIELD

The present invention relates to an inference device, an inference method and an inference program.

### BACKGROUND ART

One of information security services is a managed security service (MSS). MSS is a commercial service provided by a security operation center (SOC). For example, the SOC has roles of receiving security logs from customers and finding security threats hidden in the logs by advanced analysis within the MSS.

It is important to identify a network (NW) configuration of a client in the MSS analysis. Although active scanning for a network is well known to estimate a network configuration, active scanning itself may affect the network.

A technology for estimating a network configuration from passive information has been accordingly proposed. For example, a well-known technology is for estimating a network configuration based on IP packet information (refer to, for example, NPL 1). Moreover, another technology is known to estimate a network configuration based on, for example, event logs (refer to, for example, NPL 2).

### CITATION LIST

### Non Patent Literature

[NPL 1] Eriksson, B., Barford, P. and Nowak, R.: Network Discovery from Passive Measurement, Proc. SIGCOMM '08, pp. 291-302 (2008).
[NPL 2] Azodi, A., Cheng, F. and Meinel, C., Event Driven Network Topology Discovery and Inventory Listing Using REAMS, Wireless Personal Communications, Volume 94, Issue 3, pp. 415-430, DOI: 10.1007/s11277-0153061-3 (2017).

### SUMMARY OF INVENTION

### Technical Problem

However, conventional technologies have a common drawback that it may be difficult to identify the detailed network configuration in an organization from passive information.

For example, a technology described in NPL 1 relates to Internet topology analysis, instead of estimation of a network configuration in an organization. Moreover, for example, an approach described in NPL 2 is to perform estimation according to endpoints or services, and thus a relationship between machines may not be able to be estimated in detail.

### Solution to Problem

In order to solve the problems stated above and achieve the purpose, the inference device includes a conversion unit configured to convert information on a network into an inference rule in a predetermined format; and an inference unit configured to obtain a solution set by inference, the solution set satisfying both the inference rule in the predetermined format and a preset inference rule.

### Advantageous Effects of Invention

According to the present invention, it is possible to identify a detailed network configuration in an organization from passive information.

### BRIEF DESCRIPTION OF DRAWINGS

FIG. 1 is a diagram illustrating an overview of an inference method according to a first embodiment.

FIG. 2 is a diagram illustrating an example of a network configuration.

FIG. 3 is a diagram illustrating examples of an inference rule and a solution set.

FIG. 4 is a diagram illustrating a configuration example of the inference device according to the first embodiment.

FIG. 5 is a flowchart illustrating a flow of processing in the inference device according to the first embodiment.

FIG. 6 illustrates one example of a computer that executes an inference program.

### DESCRIPTION OF EMBODIMENTS

Embodiments of the inference device, the inference method, and the inference program according to the present application will be described in detail hereinbelow with reference to the drawings. The present invention is not limited to the embodiments described below.

### First Embodiment

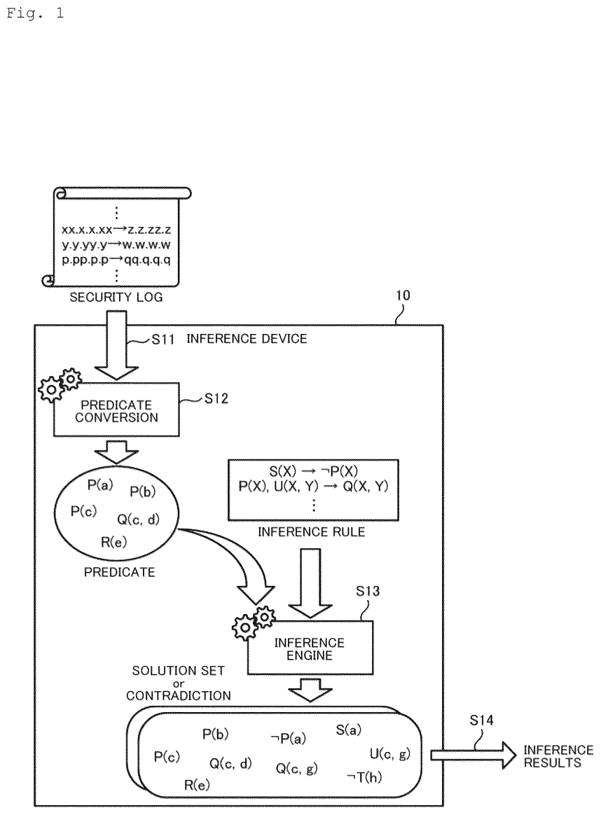

Referring to FIG. 1, an overview of the inference method executed by the inference device will be described. FIG. 1 is a diagram illustrating the overview of the inference method according to a first embodiment. As shown in FIG. 1, an inference device 10 accepts input of a security log (step S11). The term “inference” herein is a logical term, also interchangeable with “reasoning”.

The security log is one example of information on a network. Logs or traffic data output from each network device may be input to the inference device 10 instead of the security log.

The inference device 10 performs predicate conversion on the security log (step S12). The predicate conversion is a process executed in answer set programming (ASP) for converting predetermined information into a logical expression. Accordingly, the inference device 10 converts the information on a network into an inference rule in a predetermined format, that is, a fact.

References: Clingo and Gringo| Potassco, the Potsdam Answer Set Solving Collection, The University of Potsdam (available from https://potassco.org/clingo/)

The inference device 10 operates an inference engine based on the predicate obtained by the predicate conversation and a preset inference rule (step S13). The inference engine is an engine for performing inference in solution set programming. In other words, the inference device 10 obtains a fact obtained by conversion, and a solution set satisfying a preset derivation rule and a preset constraint rule by inference.

The inference device 10 outputs a solution set or contradiction, which means it is not satisfiable, obtained by inference as inference results (S14). For example, an analyst can specify a configuration example of a possible network configuration referring to the inference results output by the inference device 10.

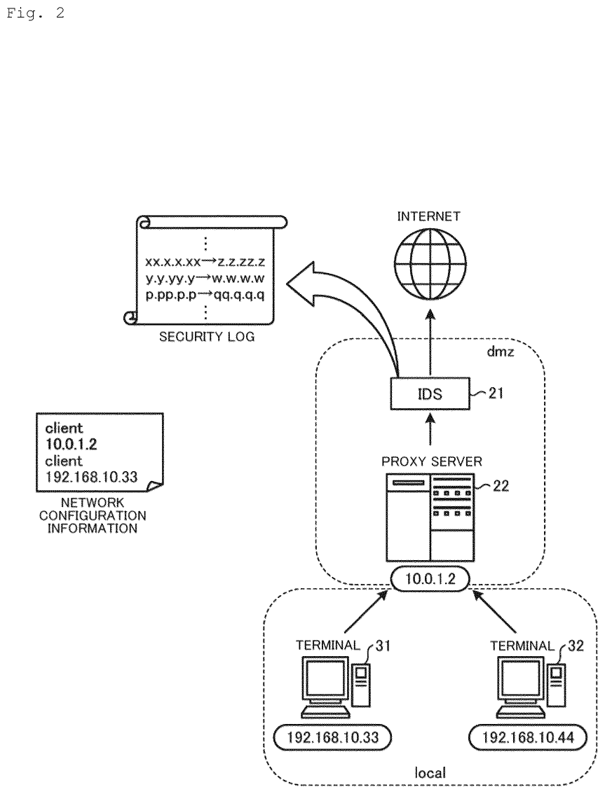

FIG. 2 shows an example of the network configuration subject to inference by the inference device 10. FIG. 2 is a diagram illustrating the example of the network configuration. As shown in FIG. 2, a network (NW) includes an intrusion detection system (IDS) 21 connected to the Internet, a proxy server 22 connected to the IDS 21, and terminals 31 and 32 respectively connected to the proxy server 22.

The IDS 21 and the proxy server are isolated by a demilitarized zone (DMZ). The terminals 31 and 32 are installed locally. The “local” or “locally” herein refers to a local area network that interconnects devices within a limited area, for example, an organization such as a business entity.

It is also assumed that the network configuration information indicates there are a client having an IP address of “10.0.1.2” and a client having an IP address of “192.168.10.33”. The network configuration information is, for example, information provided from a customer to the analyzer, and is not always accurate.

The inference device 10 derives, by inference, a first predicate indicating that the address “10.0.1.2.” is a proxy IP address and a second predicate indicating that the address “192.168.10.33” is a client IP address, on the basis of the security log. As shown in FIG. 2, “10.0.1.2” is an address of the proxy server 22. “192.168.10.33” is an address of the terminal 31.

The network configuration information indicates that the address “192.168.10.33” is a client IP address. It is not contradicted with the second predicate indicating that the address “192.168.10.33” is a client IP address.

On the other hand, the network configuration information indicates that the address “10.0.1.2” is a client IP address. In other words, it is contradicted with the first predicate indicating that the address “10.0.1.2” is a proxy IP address. In this case, it is considered that the network configuration information is wrong.

For example, the inference device 10 can perform inference on a plurality of security logs having different output dates, thereby detecting changes in the network configuration.

For example, it is assumed that the inference device 10 derives a third predicate indicating that an address “192.168.10.44” is a client IP address clip based on a security log at a certain point of time. It is also assumed that the inference device 10 derives a fourth predicate indicating that the address “192.168.10.44” is a proxy IP address based on a security log at a later point of time. However, these derived predicates are not included in the solution set because they are constrained by the constraint rule. Details of the derivation rule for deriving the predicate and the constraint rule will be described later.

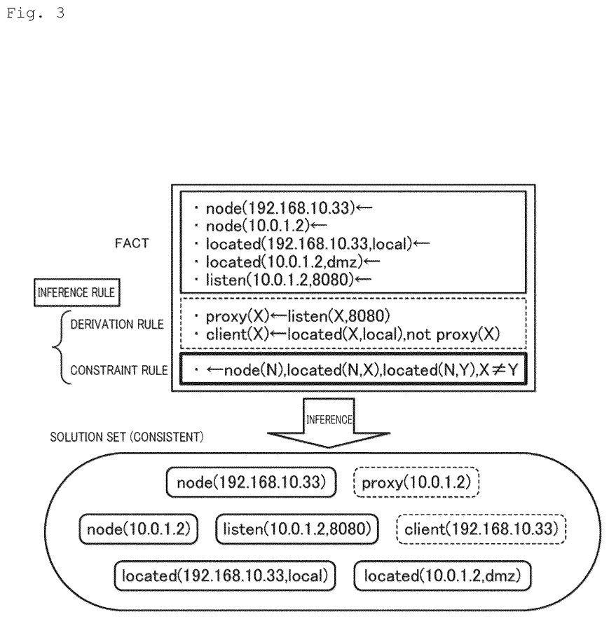

Inference by the inference device 10 will be described hereinbelow with reference to FIG. 3. FIG. 3 is a diagram illustrating examples of the inference rule and the solution set. A program is a set of rules in the solution set programming. The rule includes a fact and an inference rule. Further, in the present embodiment, it is assumed that the inference rule includes a derivation rule and a constraint rule. In the following description, the program in the solution set programming may be simply referred to as the program.

A body in the rule corresponds to a right side portion of a leftward arrow. Further, a head in the rule corresponds to a left side portion of a leftward arrow. The term “literal” refers to a predicate having a polarity of positive or negative. A predicate with a symbol “¬” at the head is a negative literal.

A fact is a rule where its head is a single literal only without a body, which means that the head is true without any premise. For example a predicate “node (10.0.1.2)” means that “10.0.1.2 exists as a node”. Therefore, a fact shown in FIG. 3, “node (10.0.1.2) ←”, means that “the statement <10.0.1.2 exists as a node> is unconditionally true”.

A predicate “located (192.168.10.33, local)”, shown in FIG. 3, means that “192.168.10.33 exists locally”. A predicate “located (10.0.1.2, dmz)” means that “10.0.1.2 is isolated by DMZ”. Further, a predicate “listen (10.0.1.2, 8080)” means that “10.0.1.2 listens on a port 8080”.

The fact is obtained by converting information on a network, such as a security log, using the inference device 10. For example, as shown in FIG. 3, a conversion unit 131 converts into a predicate at least one of information on an address existing as a node, information indicating an area on a network where an address exists, and information associating an address with a listening port.

For example, the conversion unit 131 converts the information on an address existing as a node to obtain a predicate node. For example, the conversion unit 131 converts the information on an area on a network where an address exists to obtain a predicate “located”. Further, for example, the conversion unit 131 converts the information associating an address with a listening port to obtain a predicate “listen”.

The derivation rule is an inference rule for deriving a predicate. The derivation rule is one example of a first inference rule. For example, a derivation rule “proxy (X) ← listen (X, 8080)”, shown in FIG. 3, means that “X listening on a port 8080 is a proxy”.

For example, the inference device 10 derives a predicate “proxy (10.0.1.2)” by applying the derivation rule “proxy (X) ← listen (X, 8080)” to the fact “listen (10.0.1.2, 8080) ←”.

Further, for example, the inference device 10 derives a predicate “client (192.168.10.33)” by applying the derivation rule “client (X) ← located (X, local), not proxy (X)” to the fact “located (192.168.10.33, local) ←”.

Accordingly, the inference device 10 derives a combination of predicates as a candidate for a solution set by the derivation rule from predicates obtained by converting the information on a network. The derivation rule is not limited to the rule affirming the antecedent (modus ponens) shown in FIG. 3, but may be a rule denying the consequent (modus tollens) using proof by contrapositive. The predicate of the head in the derivation rule is a candidate for a predicate to be included in a solution set.

The constraint rule is an inference rule as a constraint. The constraint rule is one example of a second inference rule. According to the constraint rule, contradiction can be derived explicitly as inference results.

The constraint rule “← node (N), located (N,X), located (N,Y), X≠Y”, shown in FIG. 3, means that “a node N exists in different areas X and Y”. A predicate constrained by the inference rule is a predicate satisfying a body of the constraint rule. On the other hand, a predicate not constrained by the inference rule is a predicate not satisfying the body of the constraint rule.

For example, the inference device 10 obtains a combination of predicates including the predicate “node (192.168.10.33)” and the predicate “node (10.0.1.2) as a candidate for a solution set based on the constraint rule “← node (N), located (N,X), located (N,Y), X≠Y”, in the example shown in FIG. 3.

If there are two facts, including a fact “located (192.168.10.33, local) ←” and fact “located (192.168.10.33, dmz) ←”, the inference device 10 excludes a combination of predicates including predicates “node (192.168.10.33)”, “located (192.168.10.33, local)” and “located (192.168.10.33, dmz) ←), as a contradicted combination, from candidates for a solution set, based on the constraint rule “← node (N), located (N,X), located (N,Y), X≠Y”; however in a case where such a combination exists as a only solution set, the inference device 10 outputs “unsatisfiable” as inference results.

As stated above, the inference device 10 excludes a combination of predicates constrained by the constraint rule from candidates for a solution set derived by the derivation rule. Predicates considered as candidates for a solution set are predicates not constrained by at least one constraint rule, and may be then excluded from a final solution set by combining a plurality of constraint rules.

A solution set is a set of predicates inferred to be consistent by the inference device 10. The solution set can be an output of a program in the solution set programming. The solution set can be a combination of predicates satisfying the fact and the inference rule. Strictly speaking, a combination of predicates that can be a solution set theoretically satisfies a certain property. For example, predicates that may or may not be present are not included in the solution set.

There is a case where a plurality of solution sets can be obtained for one program or a case where no solution set can be obtained (no solution). For example, in a case where no predicate derived from the fact based on the derivation rule is present and all the facts are considered to be contradict each other based on the constraint rule, no solution set will be obtained.

### Configuration of First Embodiment

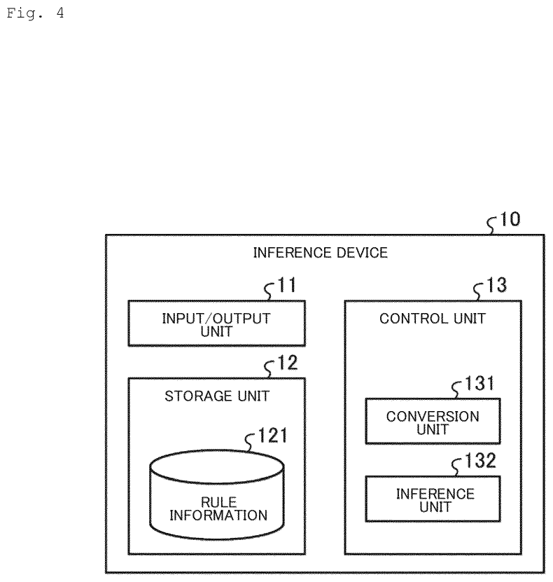

A configuration of the inference device according to the first embodiment will be described hereinbelow with reference to FIG. 4. FIG. 4 is a diagram illustrating a configuration example of the inference device according to the first embodiment. The inference device 10 accepts input of information on a network such as a security log, performs inference, and outputs inference results. As illustrated in FIG. 1, the inference device 10 includes an input/output unit 11, a storage unit 12 and a control unit 13.

The input/output unit 11 is an interface for inputting and outputting data. For example, the input/output unit 11 may be a communication interface such as a network interface card (NIC) to establish data communication with another device over a network. The input/output unit 11 may also be an interface to connect an input device such as a mouse or a keyboard, and an output device such as a display.

The storage unit 12 is a storage device such as a hard disk drive (HDD), a solid state drive (SSD) or an optical disc. The storage unit 12 may be a rewritable semiconductor memory such as a random access memory (RAM) a flash memory or a non-volatile static random access memory (NVSRAM). The storage unit 12 stores an operating system (OS) and various programs executed by the inference device 10.

The storage unit 12 stores rule information 121. The rule information 121 is an inference rule including a derivation rule and a constraint rule.

The control unit 13 controls the entire inference device 10. For example, the control unit 13 is an electronic circuit such as a central processing unit (CPU), a micro-processing unit (MPU) or a graphics processing unit (GPU), or alternatively, an integrated circuit such as an application-specific integrated circuit (ASIC) or a field-programmable gate array (FPGA). The control unit 13 also has internal memory for storing programs and control data defining various types of processing procedures, and executes processing using the internal memory. The control unit 13 also functions as various processing units by running various programs. For example, the control unit 13 has a conversion unit 131, an inference unit 132 and a search unit 133.

The conversion unit 131 converts information on a network into an inference rule in a predetermined format, that is, a fact. For example, the conversion unit 131 converts the information on a network into a predicate of the solution set programming. For example, the conversion unit 131 converts into a fact at least one of information on an address existing as a node, information indicating an area on a network where an address exists, and information associating an address with a listening port.

The inference unit 132 obtains, by inference, a combination of predicates satisfying a program consisting of the fact and a preset inference rule. For example, the inference unit 132 obtains, as a solution set, a predicate derived by the inference rule (e.g. derivation rule) from the predicates obtained by the conversion unit 131, as a candidate for a predicate to be included in a solution set. Further, for example, the inference unit 132 obtains a combination of predicates that do not contradict the inference rule (e.g. constraint rule) among the predicates obtained by the conversion unit 131 and the predicates derived by the inference unit 132.

The inference unit 132 can obtain a solution set including a predicate indicating whether a node is a client or a proxy. Further, the analyst may specify a network configuration from a solution set obtained by the inference of the inference unit 132. For example, the analyst can specify a network structure constituted by the proxy server 22 and the terminal 31, shown in FIG. 2, based on the solution set shown in FIG. 3.

(Example of Inference Rule) In addition to those illustrated in FIG. 3, the inference device 10 can use inference rules as shown in the following items (1) to (5). Items (1) to (5) are examples of derivation rules for deriving whether a node is a proxy or not.
(1) proxy (X)←tcp_dest (X,8080), not¬proxy (X)
(2) proxy (X)←tcp_dest (X,8000), not ¬proxy (X)
(3) proxy (X)←has_xff_header (X)
(4) proxy (YA)←http_req (XA,XP,YA,YP,URL), http_req
(YA, YP′, ZA, ZP, URL)
(5) ¬proxy (X)←in_global (X)

The notation “not” means it is not true, i.e. it cannot be confirmed that it is true. For example, the item (1) indicates that “If a destination of TCP communication is a port 8080 of X and it cannot be confirmed that X is not a proxy, then X is a proxy.”

Each argument of http_req corresponds to a source address, a source port, a destination address, a destination port, a URL of a HTTP request from the left. That is, the item (4) indicates that “if a source address of a first HTTP request matches a destination address YA of a second HTTP request, and both URLs match, YA may be a proxy.” However, for the item (4), other conditions may be required for arguments other than YA, such as XA and XP.

has_xff_header (X) means that a X-Forwarded-For header is added to the HTTP request transmitted by X. in_global (X) means that a node X exists on the global area network.

### Processing in First Embodiment

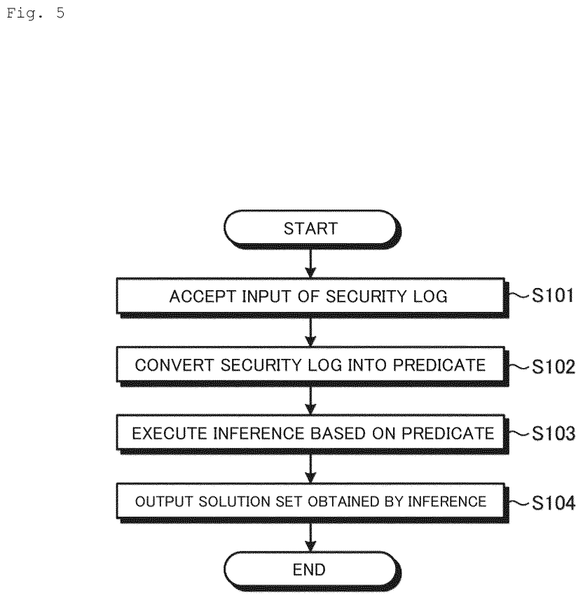

FIG. 5 is a flowchart illustrating a flow of processing in the inference device according to the first embodiment. The inference device 10 accepts input of a security log (step S101). The inference device 10 converts the security log into a predicate (step S102).

The inference device 10 performs inference on the basis of the predicate (step S103). For example, the inference device 10 derives the predicate from the fact on the basis of the derivation rule, and obtains a combination of predicates as a candidate for a solution set. Further, for example, the inference device 10 excludes candidates for a solution set, respectively including a combination of contradictory predicates, based on the constraint rule.

The inference device 10 outputs a solution set obtained by inference (step S104). The output solution set may be used when the analyst specifies the network configuration.

### Effects of First Embodiment

As described above, the conversion unit 131 converts the information on a network into the inference rule (fact) in the predetermined format. The inference unit 132 obtains, by inference, a solution set which satisfies both the inference rule (fact) in the predetermined formant and the preset inference rule (derivation rule and/or constraint rule). Since the inference device 10 converts the information on a network into the inference rule, it is possible to obtain information for specifying the network configuration by logical inference approach. Consequently, according to the present invention, it is possible to identify a detailed network configuration in an organization from passive information.

When executing the MSS, the analyst may not acquire a detailed network diagram because the network configuration is not accurately identified at a customer destination or is confidential information. Even in such a case, according to the present embodiment, the analyst can estimate the network configuration in a short time from limited available information such as a security log.

The acquired information may include errors; changes may be not reflected yet; information required for analysis may be not included; or information more than needed may be described. Even in such a case, according to the present embodiment, the analyst can identify the network configuration to the extent they need by setting proper inference rules.

The conversion unit 131 converts the information on a network into a predicate of the solution set programming. The inference unit 132 derives predicates to be included in a solution set among predicates obtained by the conversion unit 131 on the basis of the derivation rule, and derives a combination of predicates as a candidate for a solution set. Thus, the inference device 10 can derive information which is not clearly included in the fact.

The inference unit 132 excludes a combination of predicates constrained by the constraint rule from candidates for a solution set derived by the derivation rule. Thus, the inference device 10 can exclude a combination which contradict the actual network configuration included in the fact.

The inference unit 132 may exclude a combination of predicates by an implicit constraint rule in addition to the constraint rule set explicitly. In this case, for example, the inference unit 132 excludes a combination of contradictory predicates such as proxy (a) and ¬proxy (a)

The conversion unit 131 converts into a fact at least one of information on an address existing as a node, information indicating an area on a network where an address exists, and information associating an address with a listening port. Further, the inference unit 132 obtains a solution set including a predicate indicating whether a node is a client or a proxy. Therefore, the inference device 10 can obtain information on a role of each address (client or proxy) in the network.

[System Configuration, Etc.]

Each component of each device shown in the drawings is conceptual functional component and does not necessarily have a physical configuration as shown in the drawings. That is, specific modes of distribution and integration of the respective devices are not limited to those shown in the drawings, and all or any of them can be functionally or physically distributed or integrated in any unit according to, for example, various loads or usage conditions. Furthermore, processing functions executed in each device may be implemented wholly or partially by a central processing unit (CPU) or by a program analyzed and executed by the CPU. The program may be executed by other processors, such as a GPU, instead of the CPU. The program may be executed not only by the CPU but also by other processors such as the GPU.

Out of the processing steps described in the present embodiment, the processing described as being automatically executed may be performed manually in whole or in part, while the processing described as being performed manually may be performed automatically in whole or in part using a known method. Furthermore, information including processing procedures, control procedures, specific names, and various types of data and parameters set forth in the description and drawings provided above can be arbitrarily modified unless otherwise specified.

[Program]

As one embodiment, the inference device 10 can be implemented by installing an inference program for executing the inference processing stated above as package software or online software in a desired computer. For example, an information processing apparatus can serve as the inference device 10 by causing the information processing apparatus to execute the inference program. The information processing apparatus herein may be a personal computer such as a desktop PC or a laptop; a mobile communication terminal such as a smartphone, a mobile phone or a personal handyphone system (PHS); or alternatively, a slate terminal such as a personal digital assistant (PDA).

The inference device 10 can be implemented as an inference server device for providing services related to the inference processing stated above to a client that is a terminal device used by a user. For example, the inference server device is implemented as a server device that provides an inference service using a security log as an input and inference results as an output. In this case, the inference server device may be implemented as a web server, or may be implemented as a cloud that provides services related to the inference processing by outsourcing.

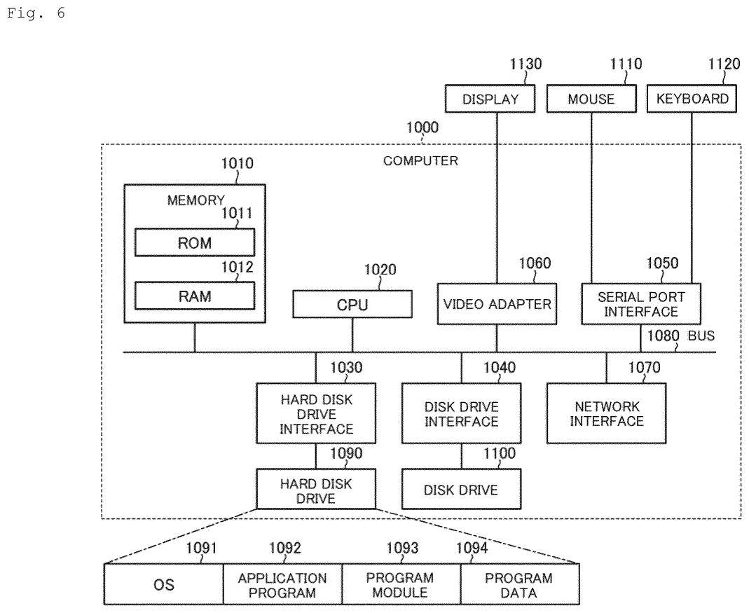

FIG. 6 is a diagram showing one example of a computer that executes the inference program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program such as a basic input/output system (BIOS). The hard disk drive interface 1030 is connected to a hard disk drive 1090. The disk drive interface 1040 is connected to a disk drive 1100. For example, a removable storage medium such as a magnetic disk and an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program for defining each processing of the inference device 10 is implemented as the program module 1093 in which codes executable by a computer are described. The program module 1093 is stored in, for example, the hard disk drive 1090. For example, the program module 1093 for executing the same processing as the functional configuration of the inference device 10 is stored in the hard disk drive 1090. The hard disk drive 1090 may be replaced by a solid state drive (SSD).

Setting data that is used in the processing of the embodiments stated above is stored as the program data 1094 in, for example, the memory 1010 or the hard disk drive 1090. The CPU 1020 reads the program module 1093 and the program data 1094 stored in the memory 1010 or the hard disk drive 1090 to the RAM 1012 as needed, and executes the processing of the embodiments described above.

The program module 1093 and program data 1094 are not limited to being stored in the hard disk drive 1090, and may also be stored in, for example, a removable storage medium and read out by the CPU 1020 via the disk drive 1100. Alternatively, the program module 1093 and program data 1094 may be stored in other computers connected via a network (for example, local area network (LAN) or wide area network (WAN)). The program module 1093 and program data 1094 may be read out from the other computers via the network interface 1070 by the CPU 1020.

### REFERENCE SIGNS LIST

10 inference device
11 input/output unit
12 storage unit
13 control unit
121 rule information
131 conversion unit
132 inference unit

1. An inference device, comprising:
conversion circuitry configured to convert information on a network into an inference rule in a predetermined format; and
inference circuitry configured to obtain a solution set by inference, the solution set satisfying both the inference rule in the predetermined format and a preset inference rule.

2. The inference device according to claim 1, wherein:
the conversion circuitry is configured to convert the information on a network into a predicate of solution set programming, and
the inference circuitry is configured to derive a combination of predicates as a candidate for a solution set by a first inference rule from predicates obtained by the conversion circuitry.

3. The inference device according to claim 2, wherein:
the inference circuitry is configured to exclude a combination of predicates constrained by a second inference rule from candidates for a solution set derived by the first interference rule.

4. The inference device according to claim 1, wherein:
the conversion circuitry is configured to convert into a logical expression at least one of information on an address existing as a node, information indicating an area on a network where an address exists, and information associating an address with a listening port.

5. The inference device according to claim 1, wherein:
the inference circuitry is configured to obtain a solution set including a predicate indicating whether a node is a client or a proxy.

6. An inference method comprising:
converting information on a network into an inference rule in a predetermined format; and
obtaining a solution set by inference, the solution set satisfying both the inference rule in the predetermined format and a preset inference rule.

7. A non-transitory computer readable medium storing an inference program for causing a computer to function as the inference device according to claim 1.

8. A non-transitory computer readable medium storing an inference program which when executed causes a computer to perform the method of claim 6.
